(19) United States
(12) Patent Application Publication
(10) Pub. No.: US 2025/0317013 A1
(43) Pub. Date: Oct. 9, 2025

(54) MAGNETIC ALIGNMENT FOR MORE ROBUST WIRELESS POWER TRANSFER

(71) Applicant: Apple Inc., Cupertino, CA (US)

(72) Inventors: Adam L Schwartz, Redwood City, CA (US); Benjamin S Morse, San Jose, CA (US); Giuseppe Pinto, San Francisco, CA (US); Zaid A AbuKhalaf, Sunnyvale, CA (US)

(21) Appl. No.: 18/938,039

(22) Filed: Nov. 5, 2024

Related U.S. Application Data
(60) Provisional application No. 63/574,930, filed on Apr. 5, 2024.

(51) Int. Cl. H02J 50/90; H02J 50/12; H02J 50/80

(52) U.S. Cl. CPC H02J 50/90; H02J 50/12; H02J 50/80

(57) ABSTRACT

Detecting an alignment accessory in a wireless power transfer (WPT) system and initiating a more robust WPT profile in response thereto can include detecting presence or absence of the alignment accessory using one or more sensors; and, responsive to the presence of the alignment accessory, enabling more robust WPT profile flag; or, responsive to the absence of the alignment accessory disabling the more robust WPT profile flag. Detecting alignment between a wireless power transmitter (PTx) and a wireless power receiver (PRx) and initiating more robust WPT profile in response thereto can include detecting alignment of the PTx and PRx; and responsive to the alignment being within a predetermined level, enabling more the robust WPT profile; or responsive to the alignment being greater than the predetermined level, disabling more robust WPT profile. The more robust WPT profile can be a magnetic power profile (MPP) from a Wireless Power Consortium Qi standard.

### CROSS-REFERENCE TO RELATED APPLICATIONS

This patent application claims benefit of U.S. Provisional Patent Application 63/574,930, entitled “Magnetic Alignment for More Robust Wireless Power Transfer,” filed Apr. 5, 2024, which is hereby incorporated by reference.

### BACKGROUND

Wireless power transfer is used in various electronic devices. For example, smart phones, tablet computers, smart watches, wireless earphones, styluses, etc. may employ wireless power transfer to facilitate charging of batteries within the devices. In some application, higher levels of wireless power transfer may be desired, for example to provide for faster charging. Such higher power transfer levels can benefit from techniques to improve alignment between the wireless power transmitter (PTx) and wireless power receiver (PRx) as well as detecting such improved alignment.

### SUMMARY

A method for detecting an alignment accessory in a wireless power transfer system including a wireless power transmitter and wireless power receiver and initiating a more robust wireless power profile than a lower performance profile in response thereto can be performed by a controller of the wireless power receiver and can include: detecting presence or absence of the alignment accessory using one or more sensors of the wireless power receiver; and responsive to the presence of the alignment accessory, enabling a more robust wireless power transfer profile flag; or responsive to the absence of the alignment accessory disabling the more robust wireless power transfer profile flag.

The method can further include detecting presence or absence of the wireless power transmitter; and in accordance with detecting presence of the alignment accessory in absence of the wireless power transmitter, enabling a more robust wireless power transfer profile flag; or in accordance with detecting absence of the alignment accessory in the presence of the wireless power transmitter, disabling a more robust wireless power transfer profile flag.

The method can further include, responsive to the more robust wireless power transfer profile flag being enabled and subsequently detecting presence of a wireless power transmitter, advertising the more robust wireless power transfer profile capability to the wireless power transmitter; or responsive to the more robust wireless power transfer profile flag being disabled and subsequently detecting presence of a wireless power transmitter, advertising one or more wireless power transfer profile capabilities different than the more robust wireless power transfer profile to the wireless power transmitter. The more robust wireless power transfer profile can be a magnetic power profile in accordance with a Qi standard promulgated by the Wireless Power Consortium. One or more wireless power transfer profile capabilities different than the more robust wireless power transfer profile to the wireless power transmitter can include at least one of a base power profile (BPP) and an enhanced power profile (EPP) in accordance with a Qi standard promulgated by the Wireless Power Consortium.

The method can further include, if the more robust wireless power transfer profile flag is enabled and a presence of a wireless power transmitter is subsequently detected, advertising the more robust wireless power transfer profile capability to the wireless power transmitter; or, if the more robust wireless power transfer profile flag is disabled and a presence of a wireless power transmitter is subsequently detected, advertising one or more wireless power transfer profile capabilities different than the more robust wireless power transfer profile to the wireless power transmitter. The more robust wireless power transfer profile can be a magnetic power profile in accordance with a Qi standard promulgated by the Wireless Power Consortium. One or more wireless power transfer profile capabilities different than the more robust wireless power transfer profile to the wireless power transmitter can include at least one of a base power profile (BPP) and an enhanced power profile (EPP) in accordance with a Qi standard promulgated by the Wireless Power Consortium.

Detecting presence or absence of the alignment accessory using one or more sensors of the wireless power receiver can include detecting one or more magnets of the alignment accessory using one or more magnetic sensors. The one or more magnetic sensors can include a Hall Effect sensor. The one or more magnetic sensors can include a magnetometer. Detecting presence or absence of the alignment accessory using one or more sensors of the wireless power receiver can include detecting one or more near field communication (NFC) tags of the alignment accessory using one or more NFC pollers or readers.

A method for detecting alignment between a wireless power transmitter and a wireless power receiver in a wireless power transfer system and initiating a more robust wireless power profile than a lower performance profile in response thereto, can be performed by a controller of the wireless power transmitter or the wireless power receiver and can include: detecting alignment of the wireless power transmitter and wireless power receiver; and responsive to the alignment being within a predetermined level, enabling the more robust wireless power transfer profile; or responsive to the alignment being greater than the predetermined level, disabling the more robust wireless power transfer profile. The more robust wireless power transfer profile can be a magnetic power profile in accordance with a Qi standard promulgated by the Wireless Power Consortium. The predetermined alignment level can be a radial offset less than or equal to 3 mm.

Detecting alignment of the wireless power transmitter and wireless power receiver can include measuring two or more electromagnetic properties of the wireless power transfer system and comparing the two or more measured electromagnetic properties to a threshold curve. The threshold curve can be derived from a regression analysis of a plurality of measurements of the two or more electromagnetic properties. The two or more measured electromagnetic properties include coupling coefficient and Q-factor. The two or more measured electromagnetic properties can include resonant frequency and Q-factor. The threshold curve can be programmed into the controller of the wireless power transmitter or wireless power receiver at manufacture.

An alignment accessory for providing improved alignment between a wireless power transmitter and a wireless power receiver forming a wireless power transfer system can include one or more features detectable by one or more sensors of the wireless power transmitter or the wireless power receiver and one or more features that provide alignment between the wireless power transmitter and wireless power receiver. The one or more features detectable by one or more sensors of the wireless power transmitter or the wireless power receiver and one or more features that provide alignment between the wireless power transmitter and wireless power receiver can include one or more magnets. The one or more magnets can be arranged in a ring disposed circumferentially about a wireless power transfer coil of the wireless power transmitter or wireless power receiver.

The alignment accessory can further include a magnetic shield disposed on the alignment accessory so as to reduce magnetic field penetration associated with the one or more magnets into at least one of the wireless power transmitter or wireless power receiver. The magnetic shield can have one or more gaps to facilitate detection of the alignment accessory by the wireless power transmitter or the wireless power receiver. The one or more features detectable by one or more sensors of the wireless power transmitter or the wireless power receiver can include a near field communication (NFC) tag.

The alignment accessory can be a case for one of the wireless power transmitter or wireless power receiver. The case can be a smartphone case.

### BRIEF DESCRIPTION OF THE DRAWINGS

FIG. 1 illustrates a simplified block diagram of a wireless power transfer system.

FIG. 2 illustrates a flowchart of a technique for detecting an alignment accessory and initiating a more robust wireless power transfer profile in response thereto.

FIG. 3 illustrates a flowchart of a technique for detecting a sufficiently precise alignment between a wireless power transmitter and a wireless power receiver and initiating a a more robust wireless power transfer profile in response thereto.

FIG. 4 illustrates exemplary configurations for detecting an alignment accessory.

FIG. 5 illustrates further aspects of magnetic detection of an alignment accessory.

FIG. 6 illustrates further aspects of magnetic detection of an alignment accessory in the presence of magnetic shielding material.

FIG. 7 illustrates aspects of detecting sufficient alignment precision between a wireless power transmitter and a wireless power receiver to activate a more robust wireless power transfer profile based on measured change in coupling coefficient and Q-factor.

FIG. 8 illustrates aspects of detecting sufficient alignment precision between a wireless power transmitter and a wireless power receiver to activate a more robust wireless power transfer profile based on measured change in resonant frequency and Q-factor.

### DETAILED DESCRIPTION

In the following description, for purposes of explanation, numerous specific details are set forth to provide a thorough understanding of the disclosed concepts. As part of this description, some of this disclosure's drawings represent structures and devices in block diagram form for sake of simplicity. In the interest of clarity, not all features of an actual implementation are described in this disclosure. Moreover, the language used in this disclosure has been selected for readability and instructional purposes, has not been selected to delineate or circumscribe the disclosed subject matter. Rather the appended claims are intended for such purpose.

Various embodiments of the disclosed concepts are illustrated by way of example and not by way of limitation in the accompanying drawings in which like references indicate similar elements. For simplicity and clarity of illustration, where appropriate, reference numerals have been repeated among the different figures to indicate corresponding or analogous elements. In addition, numerous specific details are set forth to provide a thorough understanding of the implementations described herein. In other instances, methods, procedures, and components have not been described in detail so as not to obscure the related relevant function being described. References to “an,” “one,” or “another” embodiment in this disclosure are not necessarily to the same or different embodiment, and they mean at least one. A given figure may be used to illustrate the features of more than one embodiment, or more than one species of the disclosure, and not all elements in the figure may be required for a given embodiment or species. A reference number, when provided in a given drawing, refers to the same element throughout the several drawings, though it may not be repeated in every drawing. The drawings are not to scale unless otherwise indicated, and the proportions of certain parts may be exaggerated to better illustrate details and features of the present disclosure.

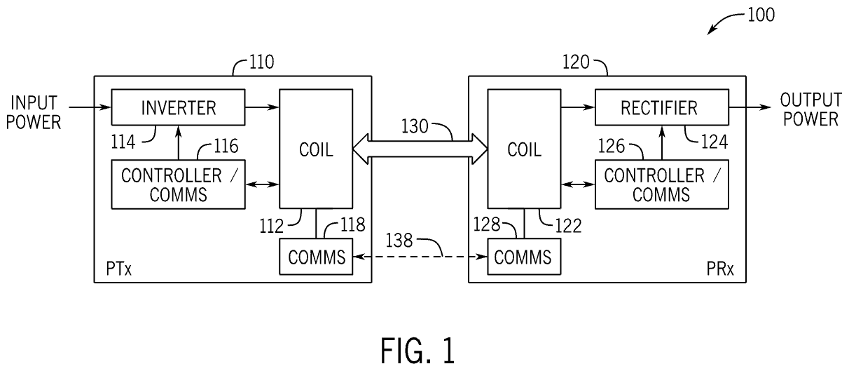

FIG. 1 illustrates a simplified block diagram of a wireless power transfer system 100. Wireless power transfer system includes a power transmitter (PTx) 110 that transfers power to a power receiver (PRx) 120 wirelessly, such as via inductive coupling 130. Power transmitter 110 may receive input power that is converted to an AC voltage having particular voltage and frequency characteristics by an inverter 114. Inverter 114 may be controlled by a controller/communications module 116 that operates as further described below. In various embodiments, the inverter controller and communications module may be implemented in a common system, such as a system based on a microprocessor, microcontroller, or the like. In other embodiments, the inverter controller may be implemented by a separate controller module and communications module that have a means of communication between them. Inverter 114 may be constructed using any suitable circuit topology (e.g., full bridge, half bridge, etc.) and may be implemented using any suitable semiconductor switching device technology (e.g., MOSFETs, IGBTs, etc. made using silicon, silicon carbide, or gallium nitride devices).

Inverter 114 may deliver the generated AC voltage to a transmitter coil 112. In addition to a wireless coil allowing magnetic coupling to the receiver, the transmitter coil block 112 illustrated in FIG. 1 may include tuning circuitry, such as additional inductors and capacitors, that facilitate operation of the transmitter in different conditions, such as different degrees of magnetic coupling to the receiver, different operating frequencies, etc. The wireless coil itself may be constructed in a variety of different ways. In some embodiments, the wireless coil may be formed as a winding of wire around a suitable bobbin. In other embodiments, the wireless coil may be formed as traces on a printed circuit board. Other arrangements are also possible and may be used in conjunction with the various embodiments described herein. The wireless transmitter coil may also include a core of magnetically permeable material (e.g., ferrite) configured to affect the flux pattern of the coil in a way suitable to the particular application. The teachings herein may be applied in conjunction with any of a wide variety of transmitter coil arrangements appropriate to a given application.

PTx controller/communications module 116 may monitor the transmitter coil and use information derived therefrom to control the inverter 114 as appropriate for a given situation. For example, controller/communications module may be configured to cause inverter 114 to operate at a given frequency or output voltage depending on the particular application. In some embodiments, the controller/communications module may be configured to receive information from the PRx device and control inverter 114 accordingly. This information may be received via the power transmission coils (i.e., in-band communication) or may be received via a separate communications channel (not shown, i.e., out-of-band communication). For in-band communication, controller/communications module 116 may detect and decode signals imposed on the magnetic link (such as voltage, frequency, or load variations) by the PRx to receive information and may instruct the inverter to modulate the delivered power by manipulating various parameters of the generated voltage (such as voltage, frequency, etc.) to send information to the PRx. In some embodiments, controller/communications module may be configured to employ frequency shift keying (FSK) communications, in which the frequency of the inverter signal is modulated, to communicate data to the PRx. Controller/communications module 116 may be configured to detect amplitude shift keying (ASK) communications or load modulation-based communications from the PRx. In either case, the controller/communications module 126 may be configured to vary the current drawn on the receiver side to manipulate the waveform seen on the Tx coil to deliver information from the PRx to the PTx. For out-of-band communication, additional modules that allow for communication between the PTx and PRx may be provided, for example, WiFi, Bluetooth, or other radio links or any other suitable communications channel.

As mentioned above, controller/communications module 116 may be a single module, for example, provided on a single integrated circuit, or may be constructed from multiple modules/devices provided on different integrated circuits or a combination of integrated and discrete circuits having both analog and digital components. The teachings herein are not limited to any particular arrangement of the controller/communications circuitry.

PTx device 110 may optionally include other systems and components, such as a separate communications module 118. In some embodiments, comms module 118 may communicate with a corresponding module tag in the PRx via the power transfer coils. In other embodiments, comms module 118 may communicate with a corresponding module using a separate physical channel 138.

As noted above, wireless power transfer system also includes a wireless power receiver (PRx) 120. Wireless power receiver can include a receiver coil 122 that may be magnetically coupled 130 to the transmitter coil 112. As with transmitter coil 112 discussed above, receiver coil block 122 illustrated in FIG. 1 may include tuning circuitry, such as additional inductors and capacitors, that facilitate operation of the transmitter in different conditions, such as different degrees of magnetic coupling to the receiver, different operating frequencies, etc. The wireless coil itself may be constructed in a variety of different ways. In some embodiments, the wireless coil may be formed as a winding of wire around a suitable bobbin. In other embodiments, the wireless coil may be formed as traces on a printed circuit board. Other arrangements are also possible and may be used in conjunction with the various embodiments described herein. The wireless receiver coil may also include a core of magnetically permeable material (e.g., ferrite) configured to affect the flux pattern of the coil in a way suitable to the particular application. The teachings herein may be applied in conjunction with any of a wide variety of receiver coil arrangements appropriate to a given application.

Receiver coil 122 outputs an AC voltage induced therein by magnetic induction via transmitter coil 112. This output AC voltage may be provided to a rectifier 124 that provides a DC output power to one or more loads associated with the PRx device. Rectifier 124 may be controlled by a controller/communications module 126 that operates as further described below. In various embodiments, the rectifier controller and communications module may be implemented in a common system, such as a system based on a microprocessor, microcontroller, or the like. In other embodiments, the rectifier controller may be implemented by a separate controller module and communications module that have a means of communication between them. Rectifier 124 may be constructed using any suitable circuit topology (e.g., full bridge, half bridge, etc.) and may be implemented using any suitable semiconductor switching device technology (e.g., MOSFETs, IGBTs, etc. made using silicon, silicon carbide, or gallium nitride devices).

PRx controller/communications module 126 may monitor the receiver coil and use information derived therefrom to control the rectifier 124 as appropriate for a given situation. For example, controller/communications module may be configured to cause rectifier 124 to operate provide a given output voltage depending on the particular application. In some embodiments, the controller/communications module may be configured to send information to the PTx device to effectively control the power delivered to the receiver. This information may be received sent via the power transmission coils (i.e., in-band communication) or may be sent via a separate communications channel (not shown, i.e., out-of-band communication). For in-band communication, controller/communications module 126 may, for example, modulate load current or other electrical parameters of the received power to send information to the PTx. In some embodiments, controller/communications module 126 may be configured to detect and decode signals imposed on the magnetic link (such as voltage, frequency, or load variations) by the PTx to receive information from the PTx. In some embodiments, controller/communications module 126 may be configured to receive frequency shift keying (FSK) communications, in which the frequency of the inverter signal has been modulated to communicate data to the PRx. Controller/communications module 126 may be configured to generate amplitude shift keying (ASK) communications or load modulation-based communications from the PRx. In either case, the controller/communications module 126 may be configured to vary the current drawn on the receiver side to manipulate the waveform seen on the Tx coil to deliver information from the PRx to the PTx. For out-of-band communication, additional modules that allow for communication between the PTx and PRx may be provided, for example, WiFi, Bluetooth, or other radio links or any other suitable communications channel.

As mentioned above, controller/communications module 126 may be a single module, for example, provided on a single integrated circuit, or may be constructed from multiple modules/devices provided on different integrated circuits or a combination of integrated and discrete circuits having both analog and digital components. The teachings herein are not limited to any particular arrangement of the controller/communications circuitry. PRx device 120 may optionally include other systems and components, such as a communications (“comms”) module 128. In some embodiments, comms module 128 may communicate with a corresponding module in the PTx via the power transfer coils. In other embodiments, comms module 128 may communicate with a corresponding module or tag using a separate physical channel 138.

Numerous variations and enhancements of the above-described wireless power transmission system 100 are possible, and the following teachings are applicable to any of such variations and enhancements.

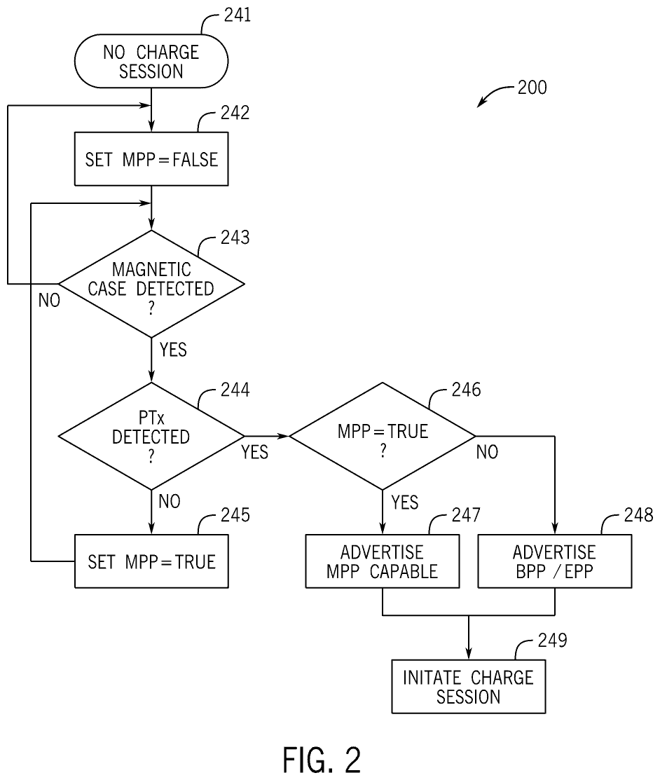

In wireless power transfer systems, relative positioning or alignment of PTx and PRx can affect the inductive or magnetic coupling between them. In at least some cases, higher degrees of alignment (i.e., closer or more precise alignment) between the wireless power transfer coils of the PTx and PRx can provide for higher inductive or magnetic coupling therebetween. This higher inductive or magnetic coupling can improve wireless power transfer from PTx to PRx, for example by increasing efficiency of the wireless power transfer, allowing higher power levels to be transferred, etc. FIG. 2 illustrates a flowchart 200 of a technique for detecting an alignment accessory and initiating a more robust wireless power transfer profile in response thereto. The alignment accessory may be associated with an electronic device, such as a wireless power receiver or a wireless power transmitter. In some embodiments, the wireless power receiver can be a personal electronic device, such as a smartphone. The alignment accessory can be a case that includes magnets or other physical features selected to improve alignment between the wireless power receiver and a wireless power transmitter having corresponding alignment features (e.g., complementary magnets). However, the techniques and principles described herein need not be limited to such embodiments. Rather, they may be applied to a variety of different wireless power transmitter or receiver types or configurations and a variety of different alignment accessory types or configurations. In any case, improved alignment afforded by the accessory can allow or trigger a more robust wireless power transfer profile, e.g., a wireless power transfer profile that transfers power at a higher power level. In some instances, the wireless power receiver and wireless power transmitter may negotiate a legacy operation profile when coupling between the devices is relatively low. Examples of legacy operating profiles include BPP (base power profile) and EPP (enhanced power profile) as defined by earlier versions of the Qi standard specification, as promulgated by the Wireless Power Consortium. In contrast to BPP or EPP operation, however, when coupling is sufficiently high, the wireless power receiver and wireless power transmitter can negotiate a more robust power profile, such as MPP (Magnetic power profile) as defined in Qi starting with version 2. Examples of how the inductive devices may negotiate legacy or more robust operating profiles is discussed in further detail below.

A technique for determining sufficient alignment, such as through the use of an alignment accessory, and initiating a more robust wireless power transfer profile in response thereto can be performed by control circuitry associated with the wireless power transmitter and/or the wireless power receiver. In the following example, the technique will be described as being performed by the wireless power receiver, although this can include certain communications with a wireless power transmitter and/or be performed in whole or in part by the wireless power transmitter, as described in greater detail below. The technique can begin at block 241 when no wireless power transfer session is ongoing. In some embodiments, wireless power transfer can be used to charge a battery in a wireless power receiver, and thus the wireless power transfer may also be described as wireless charging or charging, and thus the wireless power transfer session may be called a charge or charging session. As illustrated in block 242, the beginning of the charging session can include setting an enablement flag associated with the more robust power profile (e.g., MPP) to false, meaning that the more robust power profile is not available, and that the wireless power transmitter and wireless power receiver should negotiate a lower performance, legacy profile instead (e.g., BPP or EPP).

In at least some embodiments, MPP can allow for higher wireless power transfer rates by virtue of improved alignment between a wireless power transmitter and a wireless power receiver that can be achieved, for example, by use of complementary magnets arranged in the wireless power receiver and wireless power transmitter. As one non-limiting example, a plurality of magnets can be arranged in a ring in both wirelesses power transmitter and wireless power receiver, with the pole positioning of the magnets selected and configured so as to magnetically attach the wireless power transmitter and wireless power receiver in a determined alignment that can be expected to be more precise, and provide for higher magnetic coupling, than might be typically achieved by a user's visual positioning of the devices. Heretofore, in the absence of alignment features that provide improved alignment, the wireless power transmitter and wireless power receiver would not negotiate MPP or some other more robust wireless power transfer profiles. Thus, a wireless power transmitter and a wireless power receiver, such as a smartphone, would need to have been built with MPP or another robust wireless power transfer profiles in mind to provide the required features. However, it may be desirable in some instances to allow for the use a more robust wireless power transfer profile, such as MPP for devices that have wireless power transfer systems and circuitry that can also otherwise operate with MPP but lack the presence of features that facilitate improved coupling through magnetic attraction. Examples of these legacy profiles include BPP (base power profile) and EPP (enhanced power profile as defined in earlier Qi standard specifications) and have the necessary hardware circuitry and software programming to support the more robust MPP profile(s), but do not advertise themselves as MPP compatible because of the lack of built-in alignment magnets. The required alignment features may be provided by an alignment accessory for the wireless power receiver and or an alignment accessory for the wireless power transmitter as briefly described above and described in greater detail below. In some embodiments, these alignment features can include magnets in a predetermined configuration to align with corresponding magnets in a wireless power transmitter capable of the more robust wireless power transfer profile, such as MPP. In some embodiments, such magnets can be arranged in a case for use with a wireless power receiver device, such as a smartphone.

Thus, continuing with block 243 in FIG. 2, if an alignment accessory (e.g., a magnetic case is not detected (e.g., by the control circuitry of the wireless power receiver), then the more robust wireless power transfer profile flag (e.g., a flag indicating support for MPP operation) described above can be set/reset to false (block 242). Otherwise, if a case is detected the control circuitry can thus determine whether a wireless power transmitter is detected (block 244). Exemplary techniques for detection of an alignment accessory, such as a magnetic case, are described in greater detail below. In some embodiments, such detection can be through the detection of magnetic fields associated with the magnets of the case. It can thus be advantageous to differentiate between a magnetic field associated with an alignment accessory, such as a magnetic case, versus a magnetic field associated with a wireless power transmitter. Thus, when a magnetic case is detected in block 243, e.g., by a magnetic field signature, then the control circuitry can determine whether a wireless power transmitter is also present. Detection of a wireless power transmitter can be achieved using a variety of standardized or proprietary techniques known in the art for detecting the presence of a wireless power transmitter (or for a wireless power transmitter to detect the presence of a receiver), which are a part of initiating a wireless power transfer session.

In any case, if a wireless power receiver device detects the presence of a magnetic case (or other alignment accessory) and does not detect the presence a wireless power transmitter (that could also provide the signature), then the flag associated with the more robust wireless power profile (e.g., MPP) can be set to true (block 245). By returning to block 243, the control circuitry can ensure that so long as the case remains detected the more robust power profile flag remains enabled. Once a wireless power transmitter is detected (block 244), then the control circuitry can check, in block 246, whether the more robust wireless power transfer profile (e.g., MPP) flag is set-enabling the more robust wireless power transfer profile. If so, then, in block 247, the receiver (via its control circuitry) can advertise itself to the wireless power transmitter as being capable of the more robust wireless power transfer profile (e.g., MPP). The receiver (via its control circuitry) can thereafter initiate a wireless power transfer (charging) session (block 249). Otherwise, if the more robust wireless power transfer profile flag is not set, then the receiver can advertise itself as capable of other profiles, such as the Qi BPP or EPP profiles, or some other proprietary operation profile. The Qi-defined enhanced power profile (EPP) may be distinct from the general term “more robust wireless power transfer profile” as used herein, of which the magnetic power profile (MPP) is an example. For clarity, MPP is also referred to as the more robust wireless power transfer profile, relative to BPP and EPP.

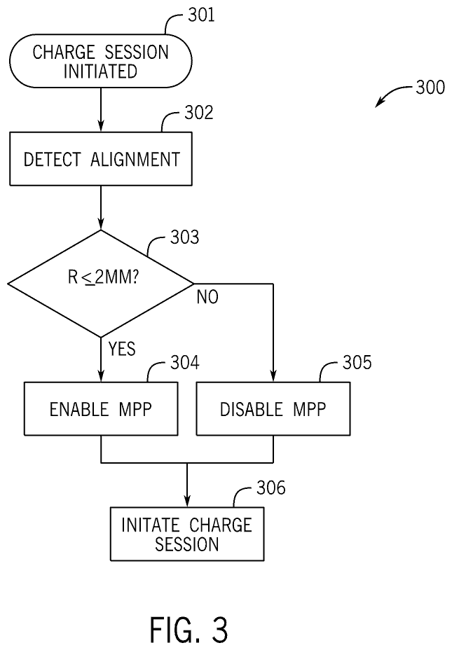

In some embodiments, it may be desirable to allow a more robust wireless power transfer profile (such as MPP) to be enabled if the requisite degree of alignment between wireless power transmitter and wireless power receiver is achieved, even in the absence of an alignment accessory. FIG. 3 illustrates a flowchart 300 of a technique for detecting a sufficiently precise alignment between a wireless power transmitter and a wireless power receiver and initiating a more robust wireless power transfer profile in response thereto. In some embodiments, this technique can be performed by a wireless power transmitter (using its control circuitry). In other embodiments, this technique can be performed by a wireless power receiver (using its control circuitry). In either case, beginning in block 301, a wireless power transfer session (i.e., charge session) can be initiated. In block 302, alignment between a wireless power transmitter and wireless power receiver can be detected. Certain aspects of exemplary techniques for alignment detection are described in greater detail below, with still further details found in Applicant's co-pending U.S. patent application Ser. No. 18/612,904, entitled “Object Detection for Wireless Power Transfer,” filed Mar. 21, 2024, which is incorporated by reference herein.

In block 303, the alignment can be compared to a threshold (block 303). As one non-limiting example, the radial offset between the center of a wireless power transmitting coil and wireless power receiving coil may be determined to be sufficiently precise if it is less than or equal to 2 mm. Depending on the particulars of a given embodiment, configuration, expected power transfer level, etc., this threshold could take on any other suitable value, such as 0.5 mm, 1 mm, 1.5 mm, 2.5 mm, 3 mm, etc. If, in block 303, it is determined that the alignment is within such threshold, then the more robust wireless power transfer profile (e.g., MPP) can be enabled (block 304), and a wireless power transfer/charging session can be initiated using such profile (block 306). Otherwise, if the alignment is not within the threshold, then the more robust wireless power transfer profile (e.g., MPP) can be disabled (block 305), and a wireless power transfer/charging session can be initiated (block 306) using another appropriate profile, e.g., BPP or EPP, as described above.

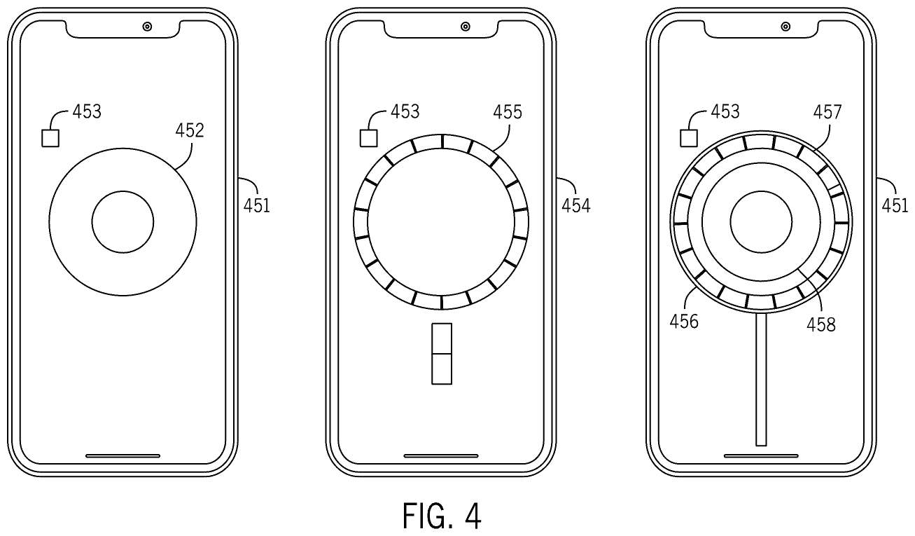

FIG. 4 illustrates exemplary configurations for detecting an alignment accessory in the form of a magnetic case. A wireless power receiver in the form of a smart phone 451 can include a wireless power transfer coil 452. The wireless power receiver can also include additional wireless power transfer circuitry and other circuitry devices not shown in FIG. 4. For enabling a more robust wireless power transfer profile such as MPP, alignment between the wireless power transfer coil 452 and a corresponding wireless power transfer coil of a transmitting device is of interest, so other components have been omitted from FIG. 4 for improved clarity. Additionally, in at least some embodiments, a smartphone (or other wireless power receiving device) could also operate as a wireless power transmitter to deliver power to an accessory device. Thus, although the following description refers to such device as a wireless power receiver, it is to be understood that in some embodiments or configurations, it could also act as a wireless power transmitter, with the same alignment benefits being applicable to either use case. In other embodiments, an alignment accessory could be used with a wireless power transmitter to provide alignment with a wireless power receiver incorporating corresponding alignment features.

Also depicted within smart phone 451 is a sensor 453 for detecting an alignment accessory, which in the example of FIG. 4 can be a magnetic case 454. Sensor 453 can take a variety of forms, such as a magnetic field sensor, a magnetometer, a Hall effect sensor, etc. In some embodiments, sensor 453 could detect the presence of an alignment accessory, such as a magnetic case by other techniques, such as near field communication (“NFC”), etc. The number, sizing, and positioning of sensor 453 in FIG. 4 is exemplary, and somewhat schematic in nature. In other words, the number, size, and placement of sensor(s) 453 can be selected based on the particular configuration of a given system.

Also depicted in FIG. 4 is an alignment accessory in the form of a magnetic case 454. Magnetic case 454 can have an overall shape and size that generally correspond to the shape and size of the corresponding wireless power transmitter or receiver, in this case smartphone 451. Magnetic case 454 can include a plurality of magnets 455, which can be positioned such that they engage with complementary magnets in a wireless power transmitter, as further described below. The position of sensor 453 is also depicted with respect to magnetic case 454; however, the sensor is in the wireless power receiver—not in the magnetic case 454/alignment accessory. In some embodiments, a complementary detection device may be positioned in case with a position that can correspond to the location of sensor 453 in the wireless power receiver. This might be the case with an NFC tag used for alignment accessory (e.g., magnetic case) detection, in which case an NFC tag could be positioned on the alignment accessory in a position more or less corresponding to the location of an NFC poller/reader device in the complementary wireless power transfer device (e.g., wireless power receiver/smartphone 451). Such configurations could also be used in the case of particular magnets or other devices used as a tag to allow identification of an alignment accessory, such as magnetic case 454 with respect to a wireless power transfer device, such as wireless power receiver/smartphone 451.

Also depicted in FIG. 4 is an exemplary positioning of sensor 453 with respect to magnets of a wireless power transmitter. The outline of wireless power receiver 451 is illustrated, along with an exemplary position of sensor 453. Also illustrated is a wireless power transmitter 456, which can include its own alignment magnets 457 and its wireless power transmitting coil 458. In some embodiments, wireless power transmitter alignment magnets 457 can cooperate with alignment accessory/magnetic case magnets 455 to provide alignment between wireless power transmitter coil 458 and wireless power receiving coil 452. As noted above, in some embodiments a wireless power receiver, such as smartphone 451 could also act as a wireless power transmitter, and thus transmitter 456 could alternatively be a wireless power receiver with corresponding magnets and coil, with alignment between the coils provided in the same way as described above.

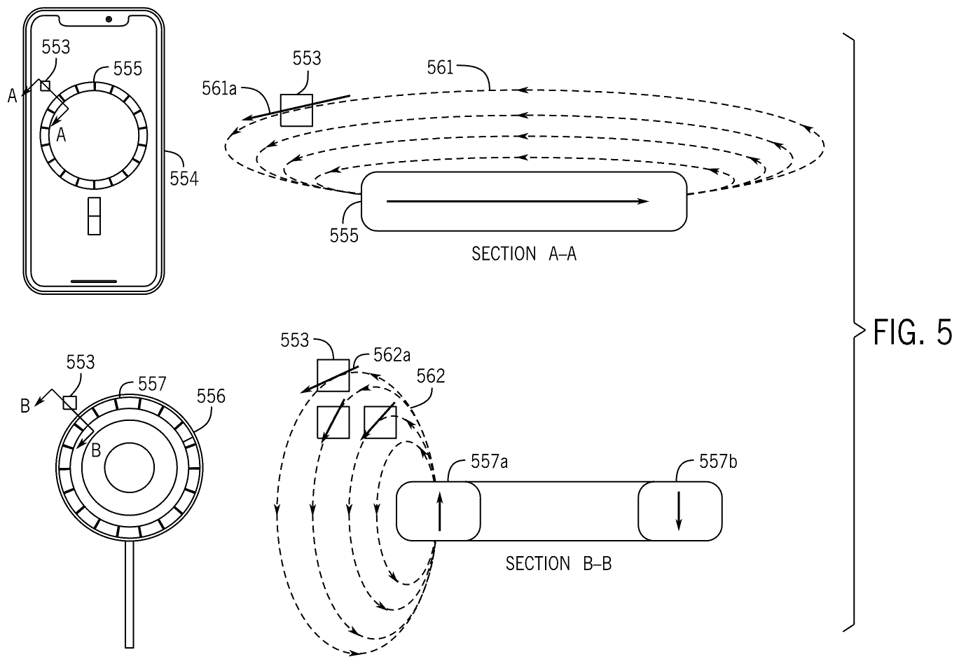

FIG. 5 illustrates further aspects of magnetic detection of an exemplary alignment accessory in the form of a magnetic case. More specifically, FIG. 5 illustrates case 554 with magnet ring 555, which can be detected by sensor 553 as described above. Section line A-A depicts a section through the illustrated magnet ring, with the corresponding fields being as depicted in Section A-A. As illustrated, the N-S poles of one or more segments of the magnet ring can be depicted to produce a magnetic field having field lines 561 as shown. A portion of the magnetic field, represented by field line 561a, may intersect sensor 553 allowing detection of the magnetic case 554. Sensor 553 can be a single-axis sensor, arranged, configured, or positioned for detecting magnetic fields in a particular direction or range of directions that will generate sufficient field strength along the axis of the sensor. Alternatively, sensor 553 can be a multi-axis sensor, which can be arranged, configured, or positioned to detect magnetic fields in multiple orientations.

FIG. 5 further illustrates aspects of detecting the presence of a wireless power transmitter 556 using sensor 553. Wireless power transmitter 556 can include one or more magnets 557 which can generate a magnetic field detected by sensor 553. Illustrated section line B-B, and corresponding Section B-B depict an exemplary arrangement. More specifically, one or more magnets 557a/557b can have pole arrangements as illustrated by the directional arrows, which can generate field lines 562. The field, represented by field lines 562a can thus be detected by one or more sensors 553 generally as described above.

Magnets 555 of the alignment accessory/case 554 and transmitter 556 (which, as noted above could alternatively be a receiver) can have their magnets arranged and oriented in any desirable configuration to provide the desired mating and alignment effects. Moreover, sensor 553 can be positioned and oriented to detect such fields, for use in a detection technique like that described above with reference to FIG. 2. Furthermore, sensor 553 can actually include multiple sensors, including even sensors of different types for further corroborating measurements. For example, multiple magnetic sensors could be provided at different locations and/or orientations to detect characteristic fields associated with particular magnet configurations at multiple locations to confirm that the magnetic field actually corresponds to the expected accessory or device and is not merely a spurious magnetic field that incidentally corresponds at one location. Additionally or alternatively, another sensor type could also be included. For example, an NFC poller/sensor could be used in conjunction with one or more magnetic sensors to detect the magnetic field or case associated with a particular case, transmitter, etc., with the NFC poller/sensor being used to read an identifying NFC tag associated with such device as an additional confirmation.

As can be inferred from FIG. 5, magnetic field shape and intensity associated with an accessory, transmitter, receiver, etc. can be controlled by various parameters including: (1) the Z-distance between the sensor(s) and magnet(s), which corresponds to the vertical distance in the depicted sectional views, (2) radial distance between the sensor(s) and magnet(s), which corresponds to the horizontal distance in the depicted sectional views, and (3) magnet orientation, design, strength, etc. Using one or more magnetic field sensors, including but not necessarily limited to 2-axis or 3-axis centers, the angle of the field relative to the magnet/magnets/magnet array can be determined. As but one example, the illustrated ring configuration may be used, and the angle of the field relative to the ring can be measured. In some embodiments, it may be desirable for the case/accessory and transmitter/receiver to have different field angles when mated together. In some embodiments the case/accessory/transmitter/receiver state could be determined by differing field shapes associated with superposition of the respective fields and/or detecting a change in field shape when an alignment accessory/magnetic case is present. Various other arrangements and configurations are also possible and need not be limited to the examples described herein.

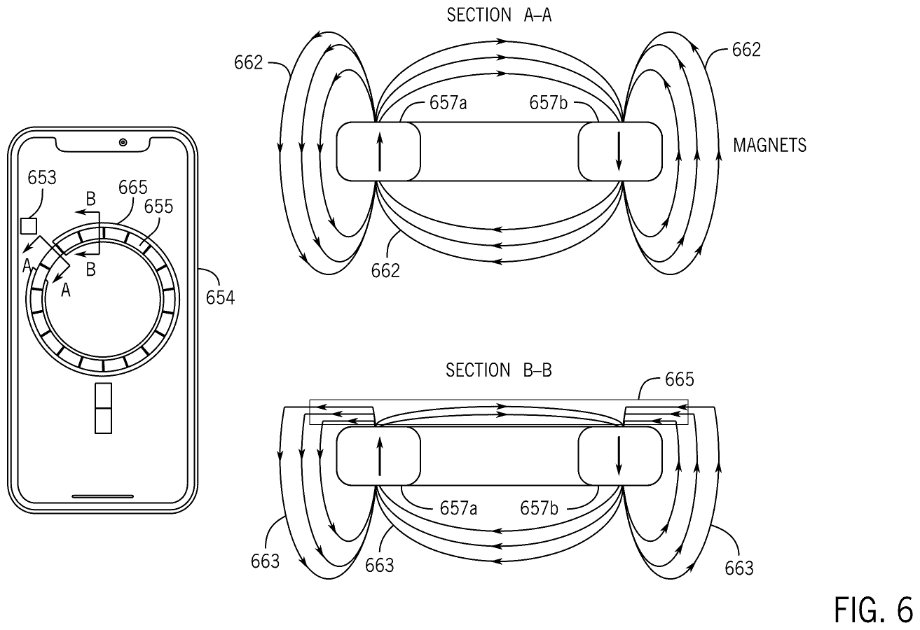

FIG. 6 illustrates further aspects of magnetic detection of an alignment accessory in the presence of magnetic shielding material. More specifically, an alignment accessory such as a magnetic case 654 can include alignment magnets 655 as described above. Additionally, magnetic shielding 665 may be provided “behind” the magnets, i.e., between the magnets and the wireless power receiver, e.g., smartphone. This magnetic shielding material may advantageously reduce the magnetic field from the magnets that reaches the interior of the wireless power receiver/smartphone, thereby preventing undesired effects such as interference with other components. Additionally, the shielding material may help to achieve in lower saturation, increasing wireless power transfer efficiency and/or increased magnetic coupling force between the accessory and wireless power receiver, e.g., smartphone.

To improve magnetic detection of the accessory/magnetic case the shield 665 can be absent from a region in proximity to sensor(s) 653. In the example of FIG. 6, shield 665 can be a ring, corresponding to the shape of the magnet ring, with a missing segment in proximity to sensor 653. Section line A-A depicts a sectional view where the magnetic shielding material is absent, and section line B-B depicts a sectional view where the magnetic shielding material is present. As illustrated in Section A-A, “up” is the direction is in the direction of the phone of a magnetic case/phone system, and “down” is in the direction of a wireless power transmitter (e.g., wireless charger). However, other configurations of both the wireless power receiver, alignment accessory, and wireless power transmitter are possible, including the transmitter and receiver being reversed, etc. As depicted in Section A-A, magnets 657a/657b can generate field lines 662 that are symmetric both upward and downward, such that the magnetic field associated with the magnets can be more readily detected by sensor 653. Conversely, Section B-B, shield 665 can redirect the field lines 663 such that they do not extend substantially upward (e.g., into the wireless power receiver/phone) while they do extend downward to allow for alignment and attachment with the wireless power transmitter (not shown in FIG. 6, but see FIGS. 4 and 5 above).

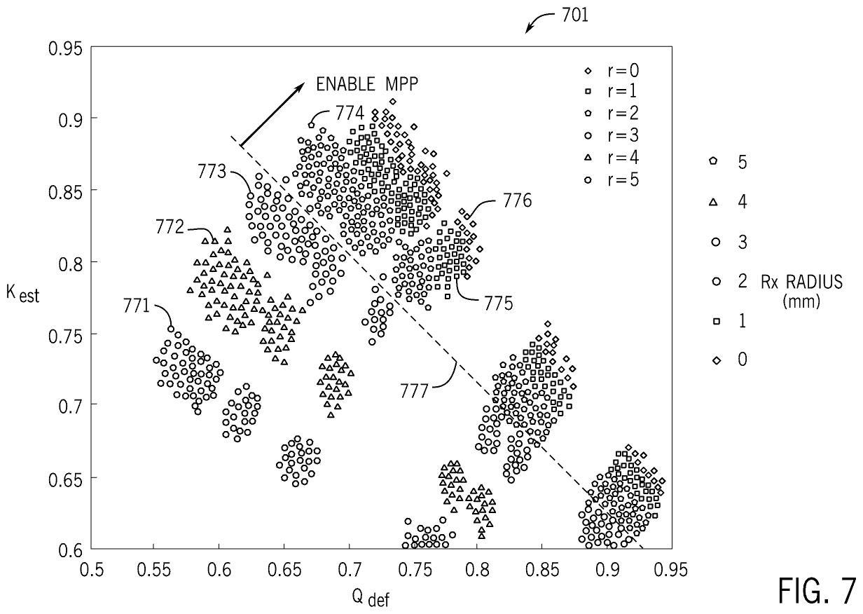

FIG. 7 illustrates aspects of detecting sufficient alignment precision between a wireless power transmitter and a wireless power receiver to activate a more robust wireless power transfer profile (e.g., MPP) based on measured change in coupling coefficient and Q-factor. By way of summary, a wireless power transmitter and/or a wireless power receiver can, using its control circuitry, perform measurements and/or estimations of various electromagnetic properties associated with the wireless power transfer link. FIG. 7 depicts a plot 701 illustrating Q-factor deflection (Q_{def}) (i.e., a change in Q factor) on the horizontal axis versus estimated coupling factor kₑₛₜ on the vertical axis. In this plot, different clusters of points represent different radial and z-height separations between the power transmitter and power receiver. As noted above, exemplary techniques for these and other measurements/estimations are described in Applicant's co-pending application identified and incorporated by reference above. The offset, more specifically radial offset or radial displacement between a wireless power transmitter coil and a wireless power receiver coil can be estimated by reference to these measurements. For example, groups of Q_{def}/kₑₛₜ measurements 771 can correspond to a relatively higher degree of radial offset, such as about 5 mm. Similarly, groups 772 can correspond to a lesser degree of offset, such as about 4 mm; groups 773 can correspond to a still lesser degree of offset, such as about 3 mm. Each of these groups can be indicative of a coupling condition between a wireless power transmitter and a wireless power receiver that do not have sufficient alignment to engage a more robust wireless power transfer protocol, such as the MPP protocol described above.

Conversely, groups of Q_{def}/kₑₛₜ measurements 774 can correspond to a relatively lower degree of radial offsets, such as about 2 mm. Similarly, groups 775 and 776 can correspond to lesser degrees of offset, such as about 1 mm and about 0 mm, respectively. Each of these groups can be indicative of a coupling condition between a wireless power transmitter and a wireless power receiver that do have sufficient alignment to engage a more robust wireless power transfer protocol, such as MPP, as described above. As a result, a curve 777 can be derived, e.g., by regression analysis of a plurality of measurements, with the curve 777 defining a threshold for engaging a more robust wireless power transfer profile, such as MPP, as described above. Thus, during operation, a wireless power transfer device can measure (Q_{def}, kₑₛₜ) and either enable or disable a more robust wireless power transfer profile such as MPP based on the location of the measured (Q_{def}, kₑₛₜ) pair versus a threshold curve programmed into the device at manufacture or by subsequent update. This can be used to provide the alignment detection described above with reference to block 302 of FIG. 3.

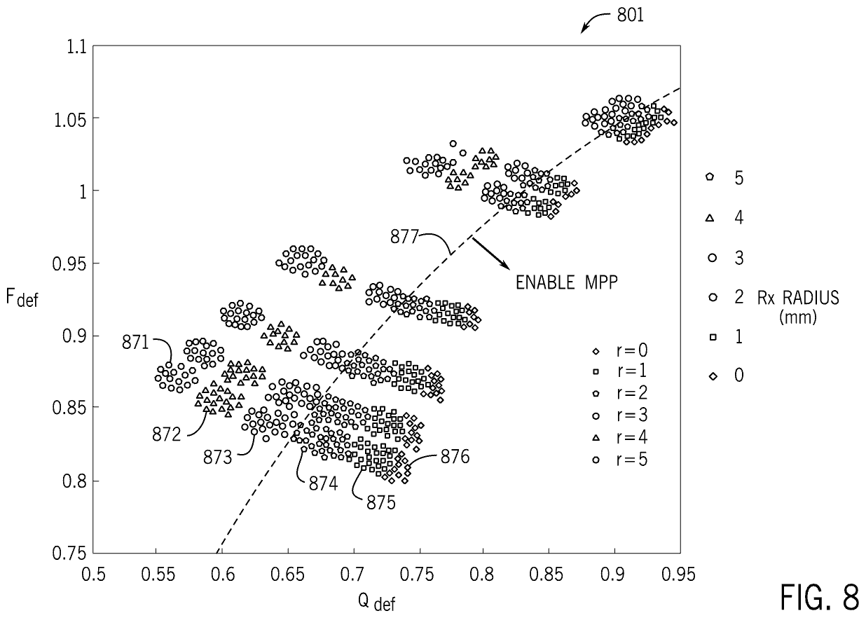

FIG. 8 illustrates aspects of detecting sufficient alignment precision between a wireless power transmitter and a wireless power receiver to activate a more robust wireless power transfer profile based on measured change in resonant frequency (F_{def}) and Q-factor (Q_{def}). Techniques for such measurements are described in Applicant's co-pending application identified and incorporated by reference above. The offset, more specifically radial offset or radial displacement between a wireless power transmitter coil and a wireless power receiver coil can be estimated by reference to these measurements. For example, groups of (Q_{def}, Fₑₛₜ) measurements 871 can correspond to a relatively higher degree of radial offset, such as about 5 mm. Similarly, groups 872 can correspond to a lesser degree of offset, such as about 4 mm; groups 873 can correspond to a still lesser degree of offset, such as about 3 mm. Each of these groups can be indicative of a coupling condition between a wireless power transmitter and a wireless power receiver that do not have sufficient alignment to engage a more robust wireless power transfer protocol, such as the MPP protocol described above.

Conversely, groups of (Q_{def}, kₑₛₜ) measurements 874 can correspond to a relatively lower degree of radial offsets, such as about 2 mm. Similarly, groups 875 and 876 can correspond to lesser degrees of offset, such as about 1 mm and about 0 mm, respectively. Each of these groups can be indicative of a coupling condition between a wireless power transmitter and a wireless power receiver that do have sufficient alignment to engage a more robust wireless power transfer protocol, such as MPP, as described above. As a result, a curve 877 can be derived, e.g., by regression analysis of a plurality of measurements, with the curve 877 defining a threshold for engaging a more robust wireless power transfer profile, such as MPP, as described above. Thus, during operation, a wireless power transfer device can measure (Q_{def}, Fₑₛₜ) and either enable or disable a more robust wireless power transfer profile such as MPP based on the location of the measured (Q_{def}, Fₑₛₜ) pair versus a threshold curve programmed into the device at manufacture or by subsequent update. This can be used to provide the alignment detection described above with reference to block 302 of FIG. 3.

The techniques described with reference and FIG. 8 may also be extended to other electromagnetic properties of the wireless power transfer system, including a wide variety of functions of Q-factor, coupling coefficient, resonant frequency, and combinations thereof, as was described in Applicant's co-pending application. This can include extension of the state space for making such determination to higher dimensions, including multiple electromagnetic parameters of the wireless power transfer system with each axis of such state space corresponding to a particular measurement or combination of measurements according to any of a variety of mathematical functions. In some embodiments, such concepts can be further extended to include one or more non-inductive observables, i.e., measurements that can be made by a wireless power transmitter and/or receiver that are not directly related to the electromagnetic coupling between the respective wireless power transfer coils. Such examples could include capacitive or other types of proximity sensors magnetic sensors similar to those described above, etc.

Described above are various features and embodiments relating to improving alignment and detecting improved alignment to improve wireless power transfer in wireless power transfer systems. Such arrangements may be used in a variety of applications but may be particularly advantageous when used in conjunction with electronic devices such as mobile phones, tablet computers, laptop or notebook computers, and accessories, such as wireless headphones, styluses, etc. Additionally, although numerous specific features and various embodiments have been described, it is to be understood that, unless otherwise noted as being mutually exclusive, the various features and embodiments may be combined various permutations in a particular implementation. Thus, the various embodiments described above are provided by way of illustration only and should not be constructed to limit the scope of the disclosure. Various modifications and changes can be made to the principles and embodiments herein without departing from the scope of the disclosure and without departing from the scope of the claims.

The foregoing describes exemplary embodiments of wireless power transfer systems that are able to transmit certain information between the PTx and PRx in the system. The present disclosure contemplates this passage of information improves the devices' ability to provide wireless power signals to each other in an efficient manner to facilitate battery charging, such as by sharing of the devices' power handling capabilities with one another. Entities implementing the present technology should take care to ensure that, to the extent any sensitive information is used in particular implementations, that well-established privacy policies and/or privacy practices are complied with. In particular, such entities would be expected to implement and consistently apply privacy practices that are generally recognized as meeting or exceeding industry or governmental requirements for maintaining the privacy of users. Implementers should inform users where personally identifiable information is expected to be transmitted in a wireless power transfer system and allow users to “opt in” or “opt out” of participation. For instance, such information may be presented to the user when they place a device onto a power transmitter, if the power transmitter is configured to poll for sensitive information from the power receiver.

1. A method for detecting an alignment accessory in a wireless power transfer system including a wireless power transmitter and wireless power receiver and initiating a more robust wireless power profile than a lower performance profile in response thereto, the method being performed by a controller of the wireless power receiver and comprising:
detecting presence or absence of the alignment accessory using one or more sensors of the wireless power receiver; and
responsive to the presence of the alignment accessory, enabling a more robust wireless power transfer profile flag; or
responsive to the absence of the alignment accessory, disabling the more robust wireless power transfer profile flag.

2. The method of claim 1 further comprising:
detecting presence or absence of the wireless power transmitter; and
in accordance with detecting presence of the alignment accessory in absence of the wireless power transmitter, enabling the more robust wireless power transfer profile flag; or
in accordance with detecting absence of the alignment accessory in the presence of the wireless power transmitter, disabling the more robust wireless power transfer profile flag.

3. The method of claim 2 further comprising:
responsive to the more robust wireless power transfer profile flag being enabled and subsequently detecting presence of a wireless power transmitter, advertising the more robust wireless power transfer profile capability to the wireless power transmitter; or
responsive to the more robust wireless power transfer profile flag being disabled and subsequently detecting presence of a wireless power transmitter, advertising one or more wireless power transfer profile capabilities different than the more robust wireless power transfer profile to the wireless power transmitter.

4. The method of claim 3 wherein:
the more robust wireless power transfer profile is a magnetic power profile in accordance with a Qi standard promulgated by the Wireless Power Consortium; and
one or more wireless power transfer profile capabilities different than the more robust wireless power transfer profile to the wireless power transmitter include at least one of a base power profile (BPP) and an enhanced power profile (EPP) in accordance with a Qi standard promulgated by the Wireless Power Consortium.

5. The method of claim 1 further comprising:
if the more robust wireless power transfer profile flag is enabled and a presence of a wireless power transmitter is subsequently detected, advertising a more robust wireless power transfer profile capability to the wireless power transmitter; or
if the more robust wireless power transfer profile flag is disabled and a presence of a wireless power transmitter is subsequently detected, advertising one or more wireless power transfer profile capabilities different than the more robust wireless power transfer profile to the wireless power transmitter.

6. The method of claim 5 wherein:
the more robust wireless power transfer profile is a magnetic power profile in accordance with a Qi standard promulgated by the Wireless Power Consortium; and
one or more wireless power transfer profile capabilities different than the more robust wireless power transfer profile to the wireless power transmitter include at least one of a base power profile (BPP) and an enhanced power profile (EPP) in accordance with a Qi standard promulgated by the Wireless Power Consortium.

7. The method of claim 1 wherein detecting presence or absence of the alignment accessory using one or more sensors of the wireless power receiver comprises detecting one or more magnets of the alignment accessory using one or more magnetic sensors.

8. The method of claim 7 wherein the one or more magnetic sensors include a Hall Effect sensor.

9. The method of claim 7 wherein the one or more magnetic sensors include a magnetometer.

10. The method of claim 1 wherein detecting presence or absence of the alignment accessory using one or more sensors of the wireless power receiver comprises detecting one or more near field communication (NFC) tags of the alignment accessory using one or more NFC pollers or readers.

11. A method for detecting alignment between a wireless power transmitter and a wireless power receiver in a wireless power transfer system and initiating a more robust wireless power profile than a lower performance profile in response thereto, the method being performed by a controller of the wireless power transmitter or the wireless power receiver and comprising:
detecting alignment of the wireless power transmitter and wireless power receiver; and
responsive to the alignment being within a predetermined level, enabling the more robust wireless power transfer profile; or
responsive to the alignment being greater than the predetermined level, disabling the more robust wireless power transfer profile.

12. The method of claim 11 wherein the more robust wireless power transfer profile is a magnetic power profile in accordance with a Qi standard promulgated by the Wireless Power Consortium.

13. The method of claim 11 wherein the predetermined alignment level is a radial offset less than or equal to 3 mm.

14. The method of claim 11 wherein detecting alignment of the wireless power transmitter and wireless power receiver further comprises measuring two or more electromagnetic properties of the wireless power transfer system and comparing the two or more measured electromagnetic properties to a threshold curve.

15. The method of claim 14 wherein the threshold curve is derived from a regression analysis of a plurality of measurements of the two or more electromagnetic properties.

16. The method of claim 14 wherein the two or more measured electromagnetic properties include coupling coefficient and Q-factor.

17. The method of claim 14 wherein the two or more measured electromagnetic properties include resonant frequency and Q-factor.

18. The method of claim 14 wherein the threshold curve is programmed into the controller of the wireless power transmitter or wireless power receiver at manufacture.

19. An alignment accessory for providing improved alignment between a wireless power transmitter and a wireless power receiver forming a wireless power transfer system, the alignment accessory comprising one or more features detectable by one or more sensors of the wireless power transmitter or the wireless power receiver and one or more features that provide alignment between the wireless power transmitter and wireless power receiver.

20. The alignment accessory of claim 19 wherein the one or more features detectable by one or more sensors of the wireless power transmitter or the wireless power receiver and one or more features that provide alignment between the wireless power transmitter and wireless power receiver comprise one or more magnets.

21. The alignment accessory of claim 20 wherein the one or more magnets are arranged in a ring disposed circumferentially about a wireless power transfer coil of the wireless power transmitter or wireless power receiver.

22. The alignment accessory of claim 20 further comprising a magnetic shield disposed on the alignment accessory so as to reduce magnetic field penetration associated with the one or more magnets into at least one of the wireless power transmitter or wireless power receiver.

23. The alignment accessory of claim 22 wherein the magnetic shield has one or more gaps to facilitate detection of the alignment accessory by the wireless power transmitter or the wireless power receiver.

24. The alignment accessory of claim 19 wherein the one or more features detectable by one or more sensors of the wireless power transmitter or the wireless power receiver include a near field communication (NFC) tag.

25. The alignment accessory of claim 19 wherein the alignment accessory is a case for one of the wireless power transmitter or wireless power receiver.

26. The alignment accessory of claim 25 wherein the case is a smartphone case.
